(19) United States
(12) Patent Application Publication
(10) Pub. No.: US 2013/0325617 A1
(43) Pub. Date: Dec. 5, 2013

(54) METHOD, SYSTEM AND FORMAT FOR PROVIDING DYNAMIC SINGLE FULL-PAGE MOBILE ADS

(71) Applicant: AIRPUSH, INC., Los Angeles, CA (US)

(72) Inventor: Asher Delug, Los Angeles, CA (US)

(73) Assignee: Airpush, Inc., Los Angeles, CA (US)

(21) Appl. No.: 13/827,519

(22) Filed: Mar. 14, 2013

Related U.S. Application Data
(63) Continuation-in-part of application No. 13/623,844, filed on Sep. 20, 2012.
(60) Provisional application No. 61/654,703, filed on Jun. 1, 2012.
(60) Provisional application No. 61/654,802, filed on Jun. 1, 2012.
(60) Provisional application No. 61/672,939, filed on Jul. 18, 2012.
(60) Provisional application No. 61/698,449, filed on Sep. 7, 2012.

(51) Int. Cl. G06Q 30/02

(52) U.S. Cl. CPC G06Q 30/0267
USPC 705/14.61; 705/14.64

(57) ABSTRACT

Among other disclosed subject matter, a computer-implemented method for displaying a mobile advertisement in a mobile device is disclosed. The method comprises selecting a media object of the mobile advertisement, where the media object is associated with a first media format of the mobile advertisement. The method further includes, determining compatibility between the first media format of the media object and a supported media format. Here, a given media object in the supported media format represents an associated mobile advertisement in one of the one or more mobile formats supported by the mobile device. When the first media format of the media object is compatible with the supported media format, converting the media object associated with the first media format into a second media object associated with the supported media format. The method further includes sending the second media object to the mobile device, where the mobile device utilizes the second media object to display the mobile advertisement.

### CLAIM OF PRIORITY

This application is a continuation-in part to U.S. Nonprovisional application Ser. No. 13/623,844 filed Sep. 20, 2012, which claims priority to U.S. Provisional Application Nos. 61/654,703, filed Jun. 1, 2012, 61/654,802 filed Jun. 1, 2012, 61/672,939, filed Jul. 18, 2012, 61/698,449, filed Sep. 7, 2012, 61/713, 421, filed Oct. 12, 2012, 61/760,952, filed Feb. 5, 2013, all of which are hereby incorporated by reference in their entireties.

### FIELD

The present invention generally relates to advertising. More particularly, the present invention relates to methods and systems for providing a dynamic full-page mobile advertisement.

### BACKGROUND

The rapid expansion of the Internet in recent years has led to the rise of internet advertising. Advertisers, content publishers, search engine sites, and advertisement (“ad”) brokers have developed an infrastructure for the delivery of ads referred to as an “ad network.” A content publisher, such as a mobile application provider, can agree to permit the delivery of ads to ad slots available between content pages of the mobile application as the content is being viewed by the mobile phone user. The ad slots comprise ad slot information that describes the advertising attributes associated with the ad slot, which are needed to select appropriate advertisements for that particular slot. The ad slot information may indicate a preferred type of ad format to be used in the ad slot.

There are many mobile ad formats for content publishers to choose from, including interstitial ads, video ads, rich media ads, offerwalls, and appwalls. The revenue the content publisher can expect to earn from each type of mobile ad format is highly variable due to the fluctuating advertisement inventory available in each ad format. Further, the expected earnings can also vary for each mobile ad format based on the wireless carriers of the mobile phone users, the type of mobile phone device used by the users, geography of the users, etc. This variability in revenue, from one mobile ad format to another, earned by the content publisher, creates a lot of confusion and wasted time amongst the content publishers in trying to determine the best mobile ad format to associate the ad slots available in their mobile applications.

Among teaching a variety of other things, certain aspects of the inventions herein have embodiments which may satisfy one or more of the above described issues.

### SUMMARY OF THE DESCRIPTION

The present invention relates to providing a dynamic, single advertisement format for mobile advertisements.

In a first aspect, a computer-implemented method for displaying a mobile advertisement in a mobile device is disclosed. The method comprises selecting a media object of the mobile advertisement, where the media object is associated with a first media format of the mobile advertisement. The method further includes, determining compatibility between the first media format of the media object and a supported media format. Here, a given media object in the supported media format represents an associated mobile advertisement in one of the one or more mobile formats supported by the mobile device. When the first media format of the media object is compatible with the supported media format, converting the media object associated with the first media format into a second media object associated with the supported media format. The method further includes sending the second media object to the mobile device, where the mobile device utilizes the second media object to display the mobile advertisement.

Additional advantageous embodiments for each of the system and method disclosed above are given in the dependent claims.

This Summary is provided to introduce a selection of concepts in a simplified form that are further described in the Detailed Description and drawings. This Summary is not intended to identify essential features of the claimed subject matter or to limit the scope of the claimed subject matter.

Implementations can include any, all or none of the following features. Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 and the following discussion provide a brief, general description of a representative environment in which the invention can be implemented;

FIGS. 2A, 2B, 2C, 2D and 2E illustrate various full-page mobile ad formats;

FIG. 3 is an illustrative example providing full-page dynamic mobile ads to a mobile user utilizing the SmartWall ad format; and

FIG. 4 is a flow diagram depicting the process for providing the full-page dynamic mobile ad utilizing the SmartWall ad format; and

FIG. 5 is a high-level block diagram showing an example of the architecture for a computer system.

The headings provided herein are for convenience only and do not necessarily affect the scope or meaning of the claimed invention.

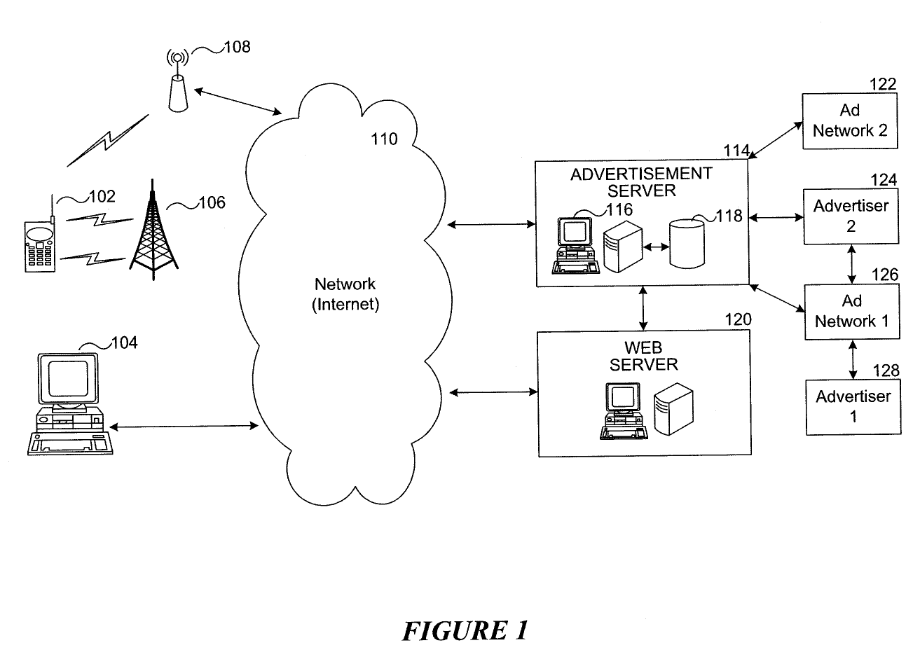

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 104 is first introduced and discussed with respect to FIG. 1).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

In the following, definitions that may be used in this description are provided. Then, environments in which, or with which, the present invention may operate are described. Thereafter, exemplary embodiment consistent with the present invention is described. Finally, some illustrative examples are provided in.

### DEFINITIONS

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, a type of targeting used (e.g., concept (which may include the specific type of concept targeting used), broad keyword, exact keyword, phrase keyword, etc.), a degree of relevancy of ad, a quality metric of a publisher of the document with which the ad was served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Conversions can also be tracked with different levels of granularity (e.g., number of items purchased, classes of items or services purchased, total purchase cost, limited to one conversion per selection in a conservative case, etc.) Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions or selections of the ad (i.e., the number of times an ad is rendered or selected) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has a unique, addressable, storage location and can therefore be uniquely identified by this addressable location. A universal resource locator (URL) is a unique address used to access information on the Internet (though instances of information may often be replicated and stored at multiple locations).

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include a computer running an internet browser (e.g., Explorer, Chrome, Firefox, etc.), a mobile device (e.g., a iPhone smartphone), media player (e.g., an MP3 player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server (e.g., a Web publisher) might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

“Ad area” may be used to describe an area (e.g., spatial and/or temporal) of a document reserved or made available to accommodate the rendering of ads. For example, Web pages often allocate a number of spots where ads can be rendered, referred to as “ad spots”. An ad spot may be able to accommodate one or more ads. As another example, an audio program may allocate “ad time slots”.

A “graphical element” may include, but is not limited to, a portable network graphics (PNG) element, a joint photographic experts group (IPEG) element, a graphics interchange format (GIF) element, a scalable vector graphics (SVG) element, a tagged image file format (TIFF) element, a bitmap, etc.

### Exemplary Advertising Environment

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 102, the personal computer 104, etc.) to connect to one or more web pages through the network 110. In one embodiment, the user's request to access to a given web page directs the user to, for example, a web server 120 that operates and provides access to the web page requested by the user.

In another instance, a content publisher, such as a mobile application developer, can agree to permit the delivery of ads to specified portions of the mobile application's content pages as the content pages are being viewed by a content consumer. Content consumers could include the mobile phone users. An advertiser could compensate the content publisher for the use of a portion of a content page or advertisement slots available between content pages of the mobile application to display the advertiser's ad.

For example, a user may run a mobile application, such as “Traffic Report” that provides the user with the latest traffic report along a given route, on their mobile phone 102. When run by the user, the mobile application may query a web server 120 to retrieve the latest traffic report along a given route. Further, the mobile application may communicate with the web server 120 to request for an ad to be placed within the content pages of the requested traffic report. In some instances, the mobile application may communicate with the web server 120 to request for an ad to be placed interleaved between content pages of the requested traffic report. Further, in some instances, the mobile application may communicate with the web server 120 to request for an ad to be placed in the notification tray of the mobile phone 102, which is outside the content pages provided by the mobile application.

In some instances, the web server 120 may communicate with the advertisement server 114 to provide one or more advertisements in conjunction with content pages offered by the web server 120 through the mobile application. The advertisement server 114 may communicate with one or more advertising agencies or other such sources of advertisements to coordinate placement of online advertisements in a variety of web pages (e.g., in the web pages displayed by the web server 120). In some instances, the advertisement server 114 is maintained by an ad broker or an advertising entity itself.

The content pages in the mobile application may be embedded with an ad “slot” in one or more of the responses. The ad slot effectively reserves a blank space on the content page as displayed to the user for subsequent insertion of an ad. In some instances, the advertisement server 114 may communicate with one or more advertising agencies or other such sources of advertisements to coordinate placement of online advertisements in a variety of content pages (e.g., in between the pages of the traffic report provided by the mobile application).

In another instance, the user's mobile application may send a request message back to the content provider to request the ad. The content provider may then send a response message back to the user with the ad appended or may forward the user ad request to the advertisement server 114 for fulfillment of the ad. In some instances, the advertisement server 114 is maintained by an ad broker or an advertising entity itself.

For example, the advertisements supplied by the advertisement server 114 to the content pages displayed to the mobile user are displayed within widgets included in the content pages of the mobile application. In some instances, the advertisements are displayed in the form of banner ads in a specified section of the content pages. In some instances, the advertisements are displayed in the mobile phone's 102 notification tray, where the advertisements will be accessible to the mobile phone user outside the mobile application. Other examples, as understood by a person of ordinary skill in the art, may also be used as equivalent variants used in conjunction with the techniques discussed herein.

The advertisements may be of any form as is understood in the industry. For example, the advertisements may be branding ads, where a video or a loop of videos or other multimedia data is played in the specified section of the content page. In another example, the advertisements may be “full-page” ads, where an advertisement take up the entire mobile screen until the ad completes or the mobile user chooses to close the ad. The “full-page” ads could be served at the beginning of a mobile application launch or at some point in the middle of an application session, such as when a mobile user completes one level of a game and is requested to watch a full-page ad before moving to the next level of the game.

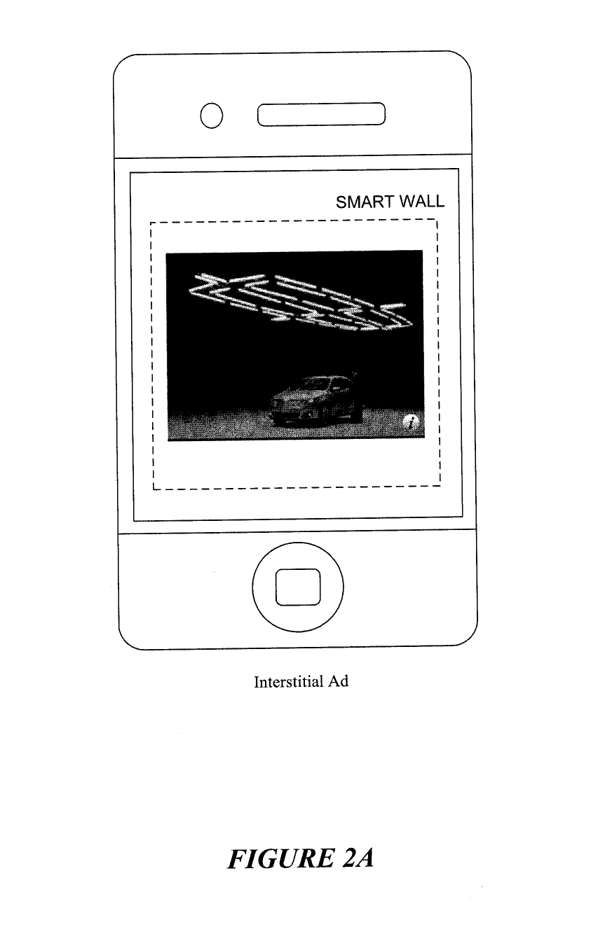

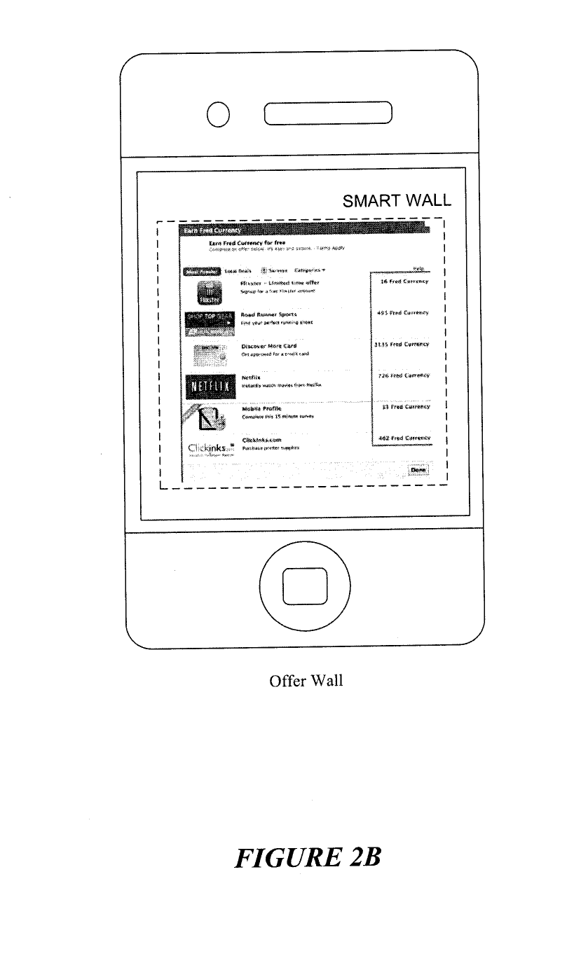

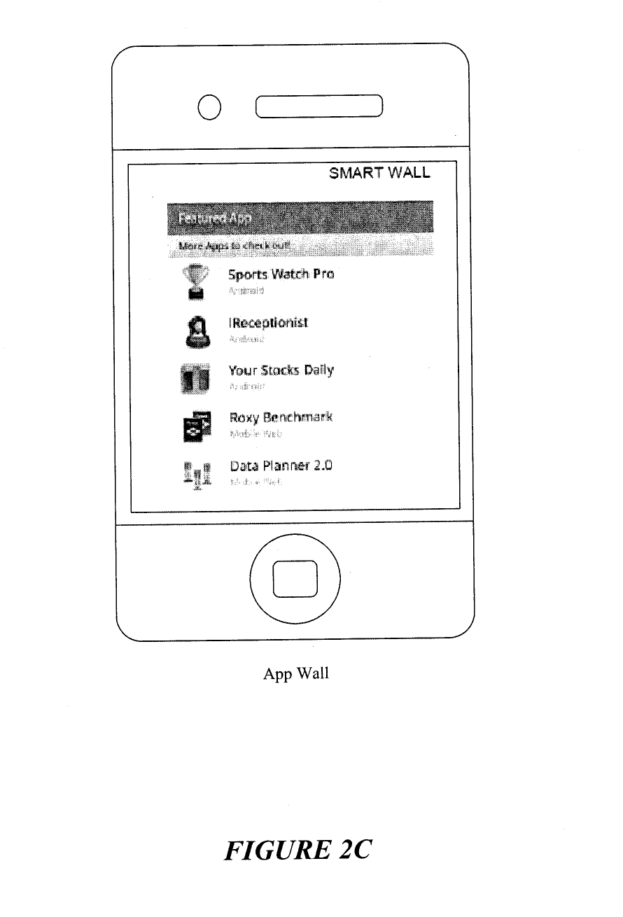

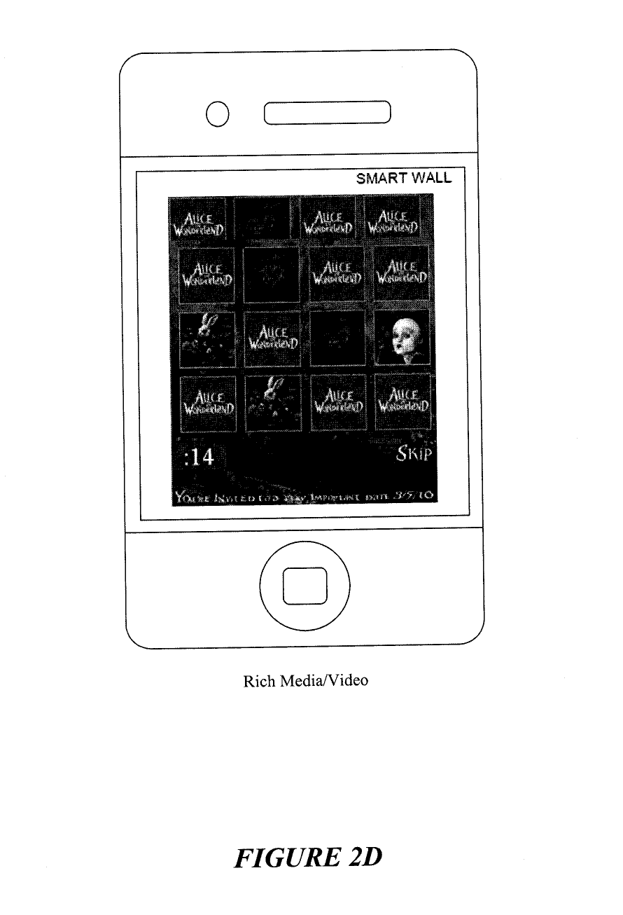

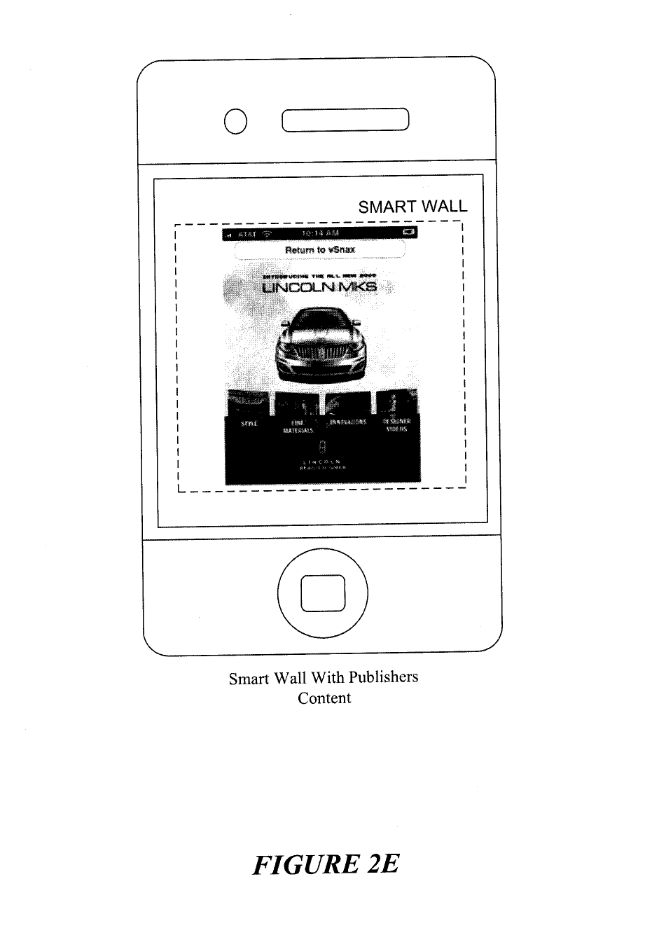

In one embodiment, the “full-page” ad may be an expandable rich media ad, as shown in FIG. 2E, with a graphical banner element incorporating one or more clickable content areas (e.g. a Scrolling or Cover Flow Ad). Clicking on one of those content areas could lead to the activation of an extended ad display area. This area could temporarily overlay the core content during the user's interaction with the ad. The extended ad space could be used to display further content, solicit user feedback, play a short game or otherwise interact with the user. By clicking a close icon, the user could make the ad expanded area disappear and reveal the core content and banner again for further use.

In another embodiment, the “full-page” ad may be an overlay rich media ad, as shown in FIG. 2D, including a graphical banner element with one or more clickable or mouse-over sensitive content areas. Upon user activation, one or more graphical ad elements appear, overlaying the core content and/or the original banner space for a short period of time. The overlay element(s) can cover the entire display screen, and can include still or animated graphics. After the short display time period has elapsed or upon the user clicking anywhere on the screen, the overlay element(s) could immediately disappear and reveal the core content and banner again for further use.

In another embodiment, the “full-page” ad may be an interstitial ad, as shown in FIG. 2A, where the ad includes a full-screen graphical element with one or more clickable or interaction content areas. The ad displays for a short time period before disappearing and allowing the user to return to the core content. By clicking a skip icon, the user can make the Interstitial Ad unit disappear and reveal the core content again for further use. Interstitial Ad units may be placed as a bumper screen for the launch and exit of the application, or as a splash or jump page within an application. It may be used as the landing page from an earlier ad banner or stand-alone.

In another embodiment, the “full-page” ad may be an offer wall ad, as shown in FIG. 2B, where the ad includes a full-screen graphical element with one or more clickable or interaction content areas. An “offer wall” is an electronic object, such as a web page, containing one or more banners, creatives, or other links associated with opportunities for users to obtain virtual currency in association with an advertisement, promotion, or sale over the Internet.

In another embodiment, the “full-page” ad may be an appwall ad, as shown in FIG. 2C, where the ad includes a full-screen graphical element with one or more clickable or interaction content areas. AppWall ads are an in-app ad format which displays a list of free apps for the user to download. The AppWall ads display by default at the beginning of each mobile application launch, but can be triggered by content publishers, such as mobile application publishers, anywhere within the application's session.

In one instance, content publishers, such as mobile application providers, can agree to permit the delivery of above described mobile ads in their varying formats to their mobile applications' content pages as the content pages are being viewed by a content consumer. An advertiser could compensate the mobile application providers for use of the mobile application as a medium to display the advertiser's ads. In some instances, the mobile application providers could provide their mobile applications for free and boost the usage of their applications, where the increased usage can provide a greater number of venues to serve paid-advertisements to mobile phone users. When the ad slots are properly monetized, the mobile application providers could not only recoup the development cost of the freely provided mobile applications, but also earn a steady stream of ad supported revenue.

Ad slot monetization refers to the amount of money paid by the advertiser to the content provider to display an advertisement. The ad payment is based on a number of factors including, but not limited to, the number of impressions delivered, the number of ‘clicks’, the number of user interactions with the advertisement, or the actual action suggested by the advertisement, such as a purchase or a registration. Embodiments of the present invention allow for both ‘OR’ and ‘AND’ combinations of payments. For example, payments can be based on payment by impression (CPM) AND payment by revenue sharing of the purchase suggested by the advertisement. Embodiments of the present invention also convert ads that utilize payments that are linked to other metrics other than number of impressions delivered to an “effective impression payment” (eCPM) to normalize all of the ad buys into a figure that is relevant to the content provider. This latter embodiment advantageously delivers the highest paying offers more often, given similar relevancy, even if there are different offers within the advertisement server 114.

The minimum price to display an advertisement is the lowest price accepted to display the advertisement within the content pages of the mobile application. The metric used for the minimum price is impression based (usually per 1,000 impressions) or per action. The actions are either a ‘click’, such as when a user interacts with the advertisement; or post-advertisement interaction, which is at the advertiser's website or install an application sponsored by the advertiser. The ad payment could be a fixed amount or a share of the revenues generated by the advertisement's post-actions.

As used herein, context classification refers to content classification, demographic classification, geographic classification, or other classification. Effective CPM (eCPM) refers to effective cost per thousand impressions. This is calculated from a particular deal's actual performance as compared to the number of impressions it took to achieve a given performance. If 1,000 impressions are shown, and 10 people click on the message and 1 person makes a $100 purchase and the deal is a 5% revenue share, then the effective CPM is $5.00.

In one instance, the ad slots in mobile applications' content pages comprises ad slot information, which describes the advertising attributes associated with the ad slot needed by the advertisement sever 114 to select appropriate advertisements for that particular slot. The advertising attributes may be determined by the content publisher or by the advertisement sever 114 if the advertisement sever 114 is in communication with the content publisher to determine ideal advertising attributes for publisher's content.

In one instance, the ad slot information includes the attribute of the maximum combined duration of advertisements to be served in the ad slot. That is each ad slot has a maximum duration for advertising purposes. Additionally, the ad slot information comprises the maximum number of advertisements that can be served in the ad slot. In one embodiment, a plurality of advertisements can be included in a single ad slot as long as the duration of the advertisements does not exceed the specified maximum duration of advertisement display. In other embodiments, only a single advertisement may be displayed in an ad slot.

Further, the ad slot information could describe the order and/or frequency with which an ad content in an ad pool should be displayed in the ad slot associated with the ad slot information. That is, the ad slot information may specify a selection policy for selecting ad content from an ad pool. For example, a selection policy may be based on the least frequently used ad content in the ad slot.

Additionally, the ad slot information includes the attribute of a relative priority of a specific ad format associated with the ad slot. Because the advertisement server 114 offers a variety of ad formats, the ad slot information may indicate the preferred types of ad formats to be used in an ad slot. For example, the ad slot information may indicate that full-page interstitial advertisements are preferred in the ad slot followed by full-page rich media advertisements. In such an instance, when available, the advertisement server 114 serves a full-page interstitial advertisement in the ad slot before a full-page rich media advertisement. Further, when multiple full-page interstitial advertisements meet the ad slot attributes, the advertisement server 114 determines the eCPM of each of the full-page interstitial advertisement and serves the full-page interstitial advertisement with the highest eCPM in the ad slot.

In embodiments, the advertisement server 114 converts full-page ads of various formats, including interstitial ads, video ads, rich media ads, offerwall ads, appwall ads, etc. into a SmartWall ad format. In one embodiment, the SmartWall ad format could be a new ad format defined specifically and used by advertisement server 114. For example, the new ad format could be an improvement of an existing ad format, such as an industry-standard MPEG format that is used to represent video and audio content.

In another embodiment, the SmartWall ad format could utilize an existing industry content format. For example, the SmartWall ad format could be in Flash Vide format, where the ad format displays advertisements in any dimensions up to the screen size of a mobile device the advertisement is viewed in. Flash Video format is a container file format used to deliver video over the Internet using Adobe Flash Player. Flash Video has been accepted as the default online video format by many sites. Some of the notable users of the Flash Video format include YouTube, Hulu, Yahoo! Video. On the other hand, appwall ads and offerwall ads could be in HTML format of varying display dimensions. The rich media ad and the video ad could be in MPEG format of display dimensions smaller than the screen size of the mobile device the advertisement is viewed in.

When the ad slot information attribute requests for a full-page ad, the advertisement server 114 serves the advertisement in SmartWall format in the ad slot. For example, in response to an ad placement request for a given ad slot, the advertisement server 114 can convert an appwall full-page ad that is provided in HTML format into SmartWall ad format (i.e. Flash format) and serve the full-page appwall ad within the ad slot in SmartWall format. Techniques for conversion of advertisements from one format to another are well known in the art and any of the known techniques can be used as long as the functional aspects of the invention are not compromised.

Similarly, techniques to enable support for an ad format in a client device, such as a mobile device, to display a given content in the ad format are well known in the art and any of the known techniques can be used as long as the functional aspects of the present invention are not compromised. For example, in one instance, Flash Video format is supported using a specific software module, such as Adobe Flash Player, that is pre-installed in the client device, such as a mobile device. In another instance, when specific software modules are not pre-installed to support Flash Video format, the multimedia content in Flash Video format is supported in a remote server that has the specific software module to support the Flash Video format. The client device communicates with the remote server to stream and display the content in a format supported in the client device.

As discussed earlier, the ad can include full-page ads of various formats, including interstitial ads, full-page video ads, rich media ads, offerwall ads, appwall ads or any other type of ad. When responding to a request for placement of a full-page ad in an ad slot, the advertisement server 114 searches an inventory of advertisements, available through advertisers 124, 128 or ad broker 122, 126, that are available for placement. The advertisement server evaluates the available full-page ads, including ads in various formats, such as interstitial, video, rich media, offerwall, appwall ads, that match the attributes associated with the ad slot requesting ad placement and chooses an ad from the available full-page ads that offers the highest bid. The chosen full-page ad is converted into SmartWall ad format and displayed in the ad slot in the SmartWall ad format.

The advertisement server 114 evaluates the available full-page ad and chooses an ad from the available full-page ads that offers the highest bid. The ads, available to the advertisement server 114, could be based on any pricing, including: cost per action (“CPA”); cost per click (“CPC”) ads; and cost per thousand impressions (“CPM”) ads. CPA may be synonymous with pay per action and revenue per action. CPC may be synonymous with pay per click and revenue per click. CPM may be synonymous with pay per thousand impressions, revenue per thousand impressions, and one thousand times cost per impression. As discussed earlier, the advertiser 124, 128 or the ad broker 122, 126 could place an ad bid in different denominations, including CPM, CPC and CPA. In embodiments, the advertisement server 114 determines the ad with the highest bid by comparing the different ads in a single “currency” of costs, so as to normalize the cost of each ad to an ad pricing currency. In some embodiments, the ad pricing currency is in effective CPM (“eCPM”.)

An equation to convert a CPM cost to an eCPM cost could simply be eCPM is equal to CPM. An equation to convert a CPC cost to an eCPM is based on a “price correlation” metric, defined as the click through rate (“CTR”): eCPM is equal to CPC multiplied by the CTR multiplied by one thousand. An equation to convert a CPA cost to an eCPM is based on a price correlation metric, defined as either the action through rate (“ATR”) or CTR: eCPM is equal to CPC multiplied by the ATR (or CTR) multiplied by one thousand.

As discussed earlier, the advertisement server 114 determines the ad to display, based on a comparison of the various ads available from one or more ad brokers and one or more advertisers. This comparison depends in part on the ad value and the specification associated with the ad slot. The advertisement server evaluates the available ads, including ads in various formats that match the attributes associated with the ad slot and chooses an ad from the available full-page ads that offers the highest eCPM bid. The chosen full-page ad is converted into SmartWall ad format and displayed in the ad slot in the SmartWall ad format.

For purpose of further illustration, it is useful to consider the techniques explained herein as it applies to mobile advertisements, such as advertisements placed in smart phones, in general. Of course, however, it should be noted that the techniques introduced here extend to advertisements in other mediums as well.

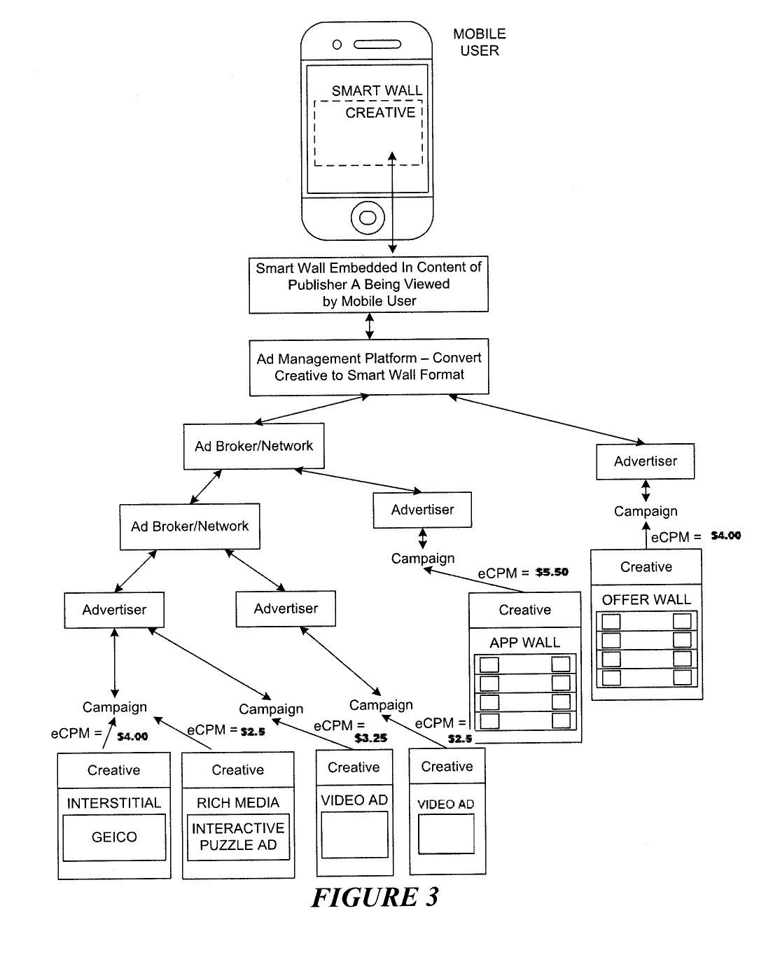

FIG. 3 is an illustrative example providing full-page dynamic mobile ads to a mobile user utilizing the SmartWall ad format. The advertisement server 114, acting as the ad management platform, interfaces with one or more advertisers and ad brokers/networks. The one or more advertisers and ad brokers/networks, possibly further interfacing with one or more advertisers and ad brokers/networks, provide the advertisement server 114 with advertisement inventory. The advertisement server 114 chooses an ad from the advertisement inventory to display in an ad slot available in a mobile application that is running in a smart phone. When choosing the ad to display in the ad slot, the advertisement server 114 considers a variety of advertisements of varying mobile ad formats, with each advertisement further having a different eCPM yield. As discussed earlier, the advertisement server 114 computes the eCPM yield of each advertisement whose attributes match the attributes associated with the ad slot. The eCPM yield is computed even for those ads whose bid price is given in other denominations, such as CPC.

Here, the interstitial creative/ad has an eCPM yield of $4.00 while the rich media creative/ad has an eCPM yield of $2.50. Further, the two video ads have a eCPM yield of $3.25 and $2.50. Additionally, the appwall ad has an eCPM yield of $5.50 while the offerwall ad has an eCPM yield of $4.00. By comparing the eCPM yield of each of the considered ad, the advertisement server 114 chooses the appwall ad that offers the highest eCPM yield of $5.50 to display in the ad slot.

The advertisement server 114 next converts the chosen appwall ad from its appwall ad format into the SmartWall format, where the appwall ad that was provided by the advertiser in HTML format is converted into a Flash Video format. The ad in the SmartWall format is then provided to the mobile device to display the ad in the ad slot. Here, the ad slot that can display SmartWall format advertisements is called a smart wall. The smart wall displays the SmartWall format advertisements by utilizing the Flash Video Player, pre-installed on the mobile device, which displays Flash Video format content.

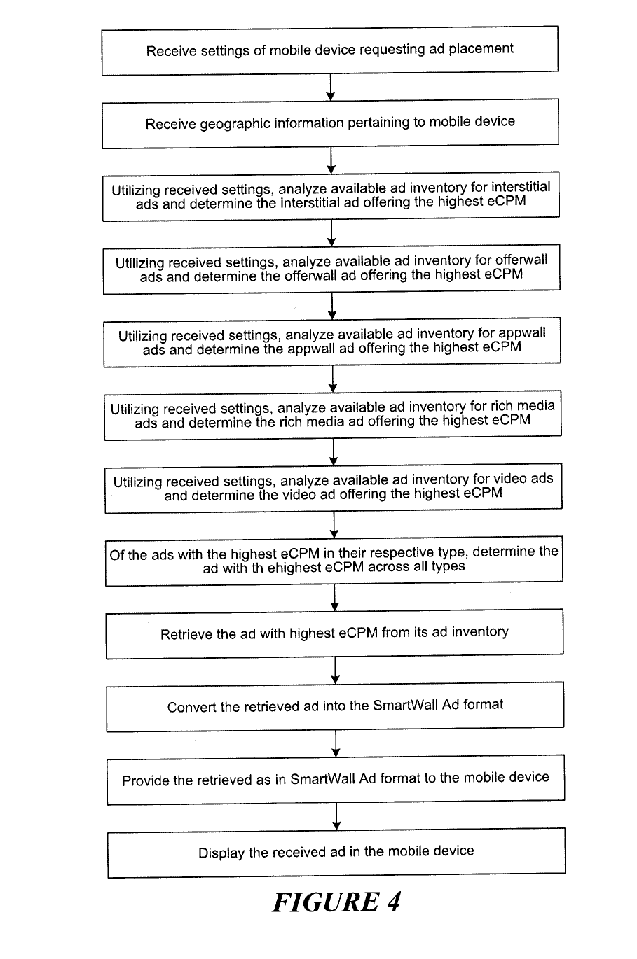

FIG. 4 is a flow diagram depicting the process for providing the full-page dynamic mobile ad utilizing the SmartWall ad format. In embodiments, the advertisement server 114 receives the settings of mobile device requesting ad placement. The settings could include information such as display screen size of the mobile device, the operating system of the mobile device, any pre-installed software to support mobile ad formats, attributes of the ad slot where the requested ad will be placed, etc. The advertisement server 114 further receives geographic information pertaining to mobile device, where such information could include the physical location of the mobile device and the country within which the physical location is mapped to.

Utilizing the received settings and the ad slot related attributes, the advertisement server 114 first analyzes the available ad inventory for interstitial ads and determines the interstitial ad that not only matches the mobile device and ad slot attributes but also offers the highest eCPM yield. Next, similar to the interstitial ad determination, the advertisement server 114 analyzes the available ad inventory for offerwall ads and determines the offerwall ad offering the highest eCPM yield while meeting the attribute requirements. Similarly, the advertisement server 114 analyzes the inventories of appwall ads, offerwall ads, rich media ads, video ads and identifies appwall, offerwall, rich media and video ads that respectively yield the highest eCPM.

From the respective ads chosen from each category of full-page mobile ads, the advertisement server 114 then identifies the ad with the highest eCPM yield across all the chosen ads. The advertisement server 114 then retrieves the identified ad with the highest eCPM yield from its ad inventory and converts the retrieved ad into the SmartWall Ad format. The advertisement server 114 then provides the advertisement in the SmartWall Ad format to the mobile device. The mobile device displays the received ad in the SmartWall embedded within the content pages of mobile applications that are running on the mobile device.

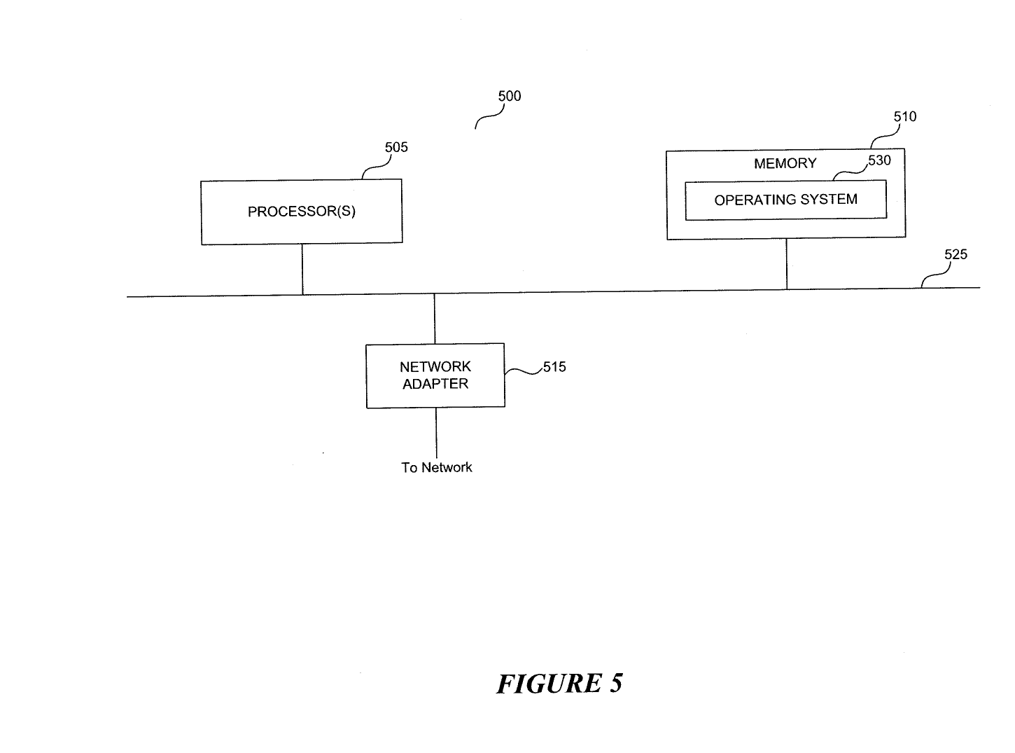

FIG. 5 is a high-level block diagram showing an example of the architecture for a computer system 500 that can be utilized to implement an advertisement server (e.g., 114 from FIG. 1), a web server (e.g., 125 from FIG. 1), etc. In FIG. 5, the computer system 500 includes one or more processors 505 and memory 510 connected via an interconnect 525. The interconnect 525 is an abstraction that represents any one or more separate physical buses, point to point connections, or both connected by appropriate bridges, adapters, or controllers. The interconnect 525, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard bus, sometimes referred to as “Firewire”.

The processor(s) 505 may include central processing units (CPUs) to control the overall operation of, for example, the host computer. In certain embodiments, the processor(s) 505 accomplish this by executing software or firmware stored in memory 510. The processor(s) 505 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 510 is or includes the main memory of the computer system 114. The memory 510 represents any form of random access memory (RAM), read-only memory (ROM), flash memory (as discussed above), or the like, or a combination of such devices. In use, the memory 510 may contain, among other things, a set of machine instructions which, when executed by processor 505, causes the processor 505 to perform operations to implement embodiments of the present invention.

Also connected to the processor(s) 505 through the interconnect 525 is a network adapter 515. The network adapter 515 provides the computer system 500 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 5 will begin with the words “means for.”) Accordingly, the applicant reserves the right to add additional claims after filing the application to pursue such additional claim forms for other aspects of the invention.

What is claimed is:

1. A method for displaying a mobile advertisement in a mobile device, the method comprising:
selecting, by a platform server, a media object of the mobile advertisement, wherein the media object is associated with a first media format of the mobile advertisement;
determining, by the platform server, compatibility between the first media format of the media object and a supported media format, wherein a given media object in the supported media format represents an associated mobile advertisement in one of the one or more mobile formats supported by the mobile device;
when the first media format of the media object is compatible with the supported media format, converting, by the platform server, the media object associated with the first media format into a second media object associated with the supported media format; and
sending, by the platform server, the second media object to the mobile device, wherein the mobile device utilizes the second media object to display the mobile advertisement.

2. The method of claim 1, wherein the first media format of the mobile advertisement includes one or more of:
an offerwall;
an appwall;
an interstitial text;
an interstitial image;
a video; or
a rich media.

3. The method of claim 1, wherein the supported media format includes media formats other than a smartwall format.

4. The method of claim 1, wherein selecting the media object of the mobile advertisement associated with the first media format further comprises:
receiving, by the platform server, a mobile advertisement placement request for the mobile device, wherein the request includes one or more advertisement preferences associated with the mobile device;
retrieving, by the platform server, one or more mobile advertisements from an advertisement database, the advertisement database including information associated with a plurality of mobile advertisements available for placement, the one or more retrieved mobile advertisements sorted by the one or more advertisement preferences included in the advertisement placement request;
determining, by the platform server, an eCPM value of each of the one or more retrieved mobile advertisements;
selecting, by the platform server, a high-yield mobile advertisement from the one or more retrieved mobile advertisements, the high-yield mobile advertisement having the highest associated eCPM value of the one or more retrieved mobile advertisements; and
selecting, by the platform server, a media object from the one or more media objects associated with the high-yield mobile advertisement, wherein the one or more media objects represent the high-yield mobile advertisement in a plurality of media formats.

5. The method of claim 1, wherein compatibility between the first media format and the supported media format is determined based on a convertibility of the media object associated with the first media format into the second media object associated with the supported media format.

6. The method of claim 4, wherein the one or more advertisement preferences associated with the mobile device includes one or more of:
a display screen size of the mobile device;
a length of a time-slot available to display a given mobile advertisement;
a general interest of a user of the mobile device; or
a category of a content displayed in the mobile device, the mobile advertisement placed within the content.

7. The method of claim 4, wherein the eCPM value of each of the one or more retrieved mobile advertisements is determined based on a bid amount associated with each of the one or more retrieved mobile advertisements, the bid amount associated with a given mobile advertisement representing the total amount an advertiser associated with the given mobile advertisement wants to pay for a unit of display of the given mobile advertisement.

8. A system comprising:
a processor;
a memory configured to store a set of instructions, which when executed by the processor cause the system to perform a method, the method including:
selecting a media object of the mobile advertisement, wherein the media object is associated with a first media format of the mobile advertisement;
determining compatibility between the first media format of the media object and a supported media format, wherein a given media object in the supported media format represents an associated mobile advertisement in one of the one or more mobile formats supported by the mobile device;
when the first media format of the media object is compatible with the supported media format, converting the media object associated with the first media format into a second media object associated with the supported media format; and
sending the second media object to the mobile device, wherein the mobile device utilizes the second media object to display the mobile advertisement.

9. The system of claim 8, wherein the first media format of the mobile advertisement includes one or more of:
an offerwall;
an appwall;
an interstitial text;
an interstitial image;
a video; or
a rich media.

10. The system of claim 8, wherein the supported media format includes media formats other than a smartwall format.

11. The system of claim 8, wherein selecting the media object of the mobile advertisement associated with the first media format further comprises:
receiving a mobile advertisement placement request for the mobile device, wherein the request includes one or more advertisement preferences associated with the mobile device;
retrieving one or more mobile advertisements from an advertisement database, the advertisement database including information associated with a plurality of mobile advertisements available for placement, the one or more retrieved mobile advertisements sorted by the one or more advertisement preferences included in the advertisement placement request;
determining an eCPM value of each of the one or more retrieved mobile advertisements;
selecting a high-yield mobile advertisement from the one or more retrieved mobile advertisements, the high-yield mobile advertisement having the highest associated eCPM value of the one or more retrieved mobile advertisements; and
selecting a media object from the one or more media objects associated with the high-yield mobile advertisement, wherein the one or more media objects represent the high-yield mobile advertisement in a plurality of media formats.

12. The system of claim 8, wherein compatibility between the first media format and the supported media format is determined based on a convertibility of the media object associated with the first media format into the second media object associated with the supported media format.

13. The system of claim 11, wherein the one or more advertisement preferences associated with the mobile device includes one or more of:
a display screen size of the mobile device;
a length of a time-slot available to display a given mobile advertisement;
a general interest of a user of the mobile device; or
a category of a content displayed in the mobile device, the mobile advertisement placed within the content.

14. The system of claim 11, wherein the eCPM value of each of the one or more retrieved mobile advertisements is determined based on a bid amount associated with each of the one or more retrieved mobile advertisements, the bid amount associated with a given mobile advertisement representing the total amount an advertiser associated with the given mobile advertisement wants to pay for a unit of display of the given mobile advertisement.

15. A system for displaying a mobile advertisement in a mobile device, the system comprising:
a means for selecting a media object of the mobile advertisement, wherein the media object is associated with a first media format of the mobile advertisement;
a means for determining compatibility between the first media format of the media object and a supported media format, wherein a given media object in the supported media format represents an associated mobile advertisement in one of the one or more mobile formats supported by the mobile device;
when the first media format of the media object is compatible with the supported media format, a means for converting the media object associated with the first media format into a second media object associated with the supported media format; and
a means for sending the second media object to the mobile device, wherein the mobile device utilizes the second media object to display the mobile advertisement.

16. The system of claim 15, wherein the first media format of the mobile advertisement includes one or more of:
an offerwall;
an appwall;
an interstitial text;
an interstitial image;
a video; or
a rich media.

17. The system of claim 15, wherein the supported media format includes media formats other than a smartwall format.

18. The system of claim 15, wherein selecting the media object of the mobile advertisement associated with the first media format further comprises:
a means for receiving a mobile advertisement placement request for the mobile device, wherein the request includes one or more advertisement preferences associated with the mobile device;
a means for retrieving one or more mobile advertisements from an advertisement database, the advertisement database including information associated with a plurality of mobile advertisements available for placement, the one or more retrieved mobile advertisements sorted by the one or more advertisement preferences included in the advertisement placement request;
a means for determining an eCPM value of each of the one or more retrieved mobile advertisements;
a means for selecting a high-yield mobile advertisement from the one or more retrieved mobile advertisements, the high-yield mobile advertisement having the highest associated eCPM value of the one or more retrieved mobile advertisements; and
a means for selecting a media object from the one or more media objects associated with the high-yield mobile advertisement, wherein the one or more media objects represent the high-yield mobile advertisement in a plurality of media formats.

19. The system of claim 15, wherein compatibility between the first media format and the supported media format is determined based on a convertibility of the media object associated with the first media format into the second media object associated with the supported media format.

20. The system of claim 18, wherein the one or more advertisement preferences associated with the mobile device includes one or more of:
a display screen size of the mobile device;
a length of a time-slot available to display a given mobile advertisement;
a general interest of a user of the mobile device; or
a category of a content displayed in the mobile device, the mobile advertisement placed within the content.

21. The system of claim 18, wherein the eCPM value of each of the one or more retrieved mobile advertisements is determined based on a bid amount associated with each of the one or more retrieved mobile advertisements, the bid amount associated with a given mobile advertisement representing the total amount an advertiser associated with the given mobile advertisement wants to pay for a unit of display of the given mobile advertisement.
